(19) United States
(12) Patent Application Publication
(10) Pub. No.: US 2012/0134748 A1
(43) Pub. Date: May 31, 2012

(54) EROSION BARRIER METHOD AND APPARATUS

(75) Inventor: Joseph Santamaria, Alexandria, NH (US)

(73) Assignee: JPS Industries, Inc., Bristol, NH (US)

(21) Appl. No.: 12/956,662

(22) Filed: Nov. 30, 2010

(51) Int. Cl. E02D 31/06; E02B 3/16; B65G 5/00

(52) U.S. Cl. 405/53; 405/270

(57) ABSTRACT

An erosion barrier wastewater treatment system and in particular a liner for a wastewater treatment lagoon wherein the lagoon may be any earthen basin for containing a body of water, for instance wastewater, and the liner is utilized mainly for reducing the erosion of the lagoon walls due to water turbulence, the liner being formed from panels of material that can be constructed and implemented inexpensively and without interruption of facility operation for installation of the device.

### FIELD OF THE INVENTION

The present invention relates to an erosion barrier wastewater treatment system and in particular to a liner for a wastewater treatment lagoon. The lagoon may be any earthen basin for containing a body of water, for instance wastewater, and the liner is utilized mainly for reducing the erosion of the lagoon walls due to water turbulence.

### BACKGROUND OF THE INVENTION

Conventional lagoon based wastewater treatment systems rely generally on open air lagoons to permit aerobic and anaerobic treatment of wastewater. A lagoon is any earthen basin for containing a body of water, such as a treatment reactor cell. Lagoons and other wastewater treatment ponds or basins are typically constructed by excavating land to create a reservoir area. If desired, berms can then be built around the perimeter of the reservoir area to extend the walls of the reservoir above ground level. Quite often, a lagoon is lined with a layer of clay to serve as a barrier. For example, environmental regulations typically require a subgrade clay layer of uniform thickness, for example 5 feet thick and having uniform water content. Often times a plastic liner made of high-density polyethylene may be placed over the entire interior surface defined by the reservoir and the berm area. The liner is made of sheet strips of high density polyethylene (HDPE) which overlap in an abutting fashion and are then welded or cemented together to create a water impermeable and erosion control line.

Once the lagoon is constructed and lined the wastewater liquid or sludge material is then pumped into the lagoon on top of the liner and/or the clay which is lining the lagoon. This liner facilitates not only maintaining the wastewater in the reservoir or lagoon but also in maintaining any turbulent water flow in the surface from eroding the berm and banking of the lagoon. The lagoon or pond is the subject to water fluid level changes as well as a turbulence of the surface in particular from aeration of the wastewater which can erode the banking and the berm. The liner is instrumental in protecting the underlying clay and soil lining forming the lagoon particularly where the turbulent water contacts the berm and banking.

Lagoon based water treatment systems require a large amount of space, on the order of several acres and often necessitate the large interior encompassing liner in conjunction with the lagoon construction to facilitate containment of the wastewater and to prevent erosion of the banking around the lagoon. This is tremendously expensive where an entire lagoon system must be covered with a liner, not only upon initial construction but upon replacement or fixing of a compromised liner.

Such traditional lagoon-based liner systems have several shortcomings. Because of the large size of the liners where the liners cover the entire interior of the lagoon, the liners which are generally impermeable material must be constructed on-site usually in large strips, where the strips are heat sealed together along their edges after being placed in an empty a lagoon. This of course means that the lagoon must be emptied and cannot be used for the time period in which the new liner material is placed inside. It is tremendously labor intensive, time-consuming and expensive to assemble such liners and empty the lagoons if a liner needs to be fixed or replaced.

### SUMMARY OF THE INVENTION

The liner system of the present invention is a significant savings in material and man-hours to implement because the lagoon does not need to be drained, or operation even interrupted in most cases to construct and implement the erosion liner system. The liner is in effect a skirt which entirely surrounds the lagoon but does not need to extend and cover throughout the entire interior surface area of the lagoon. However, it is to be appreciated that the liner may extend to any length necessary to cover an interior surface as required. The skirt may be placed around the outside edge, banking and berm of the lagoon so that the there is no down time for the wastewater treatment facility. Also, the panels of the skirt may be fit together by a simpler less labor intensive means because all the edges do not have to be sealed between all the panels such as in the prior art liners.

In general the skirt is manufactured in manageable sections for instance in 50×20 foot rectangular sections which can be manufactured off-site, brought to the site and connected together along their edges with stainless steel bolts. The side edges of each section do not need to be entirely sealed because the skirt is concerned mainly with preventing erosion and ensuring that such erosion does not occur along the top of the lagoon wall where turbulence from aeration or other mechanical processes to the wastewater may erode the lagoon banking or berm.

### BRIEF DESCRIPTION OF THE DRAWINGS

Several embodiments of the present invention will now be described by way of example only, with reference to the accompanying drawings in which:

FIG. 1 is a diagrammatic representation of a wastewater treatment plant;

FIG. 2 is a cross section of a lagoon;

FIG. 3 is a first embodiment of a panel of the present invention;

FIGS. 4A-4B are further embodiments of a panel of the present invention;

FIGS. 5A-5B are embodiments of a corner panel of the present invention;

FIGS. 6A-6C are further embodiments of a panel of the present invention;

FIG. 7 is the affixed panels of FIGS. 6A-6C;

FIG. 8 is a diagrammatic plan view of an embodiment of a plurality of panels of the present invention;

FIG. 9 is a perspective view of a lagoon with an embodiment of the present invention; and

FIG. 10 is a cross section of an embodiment of a panel of the present invention.

### DETAILED DESCRIPTION OF THE INVENTION

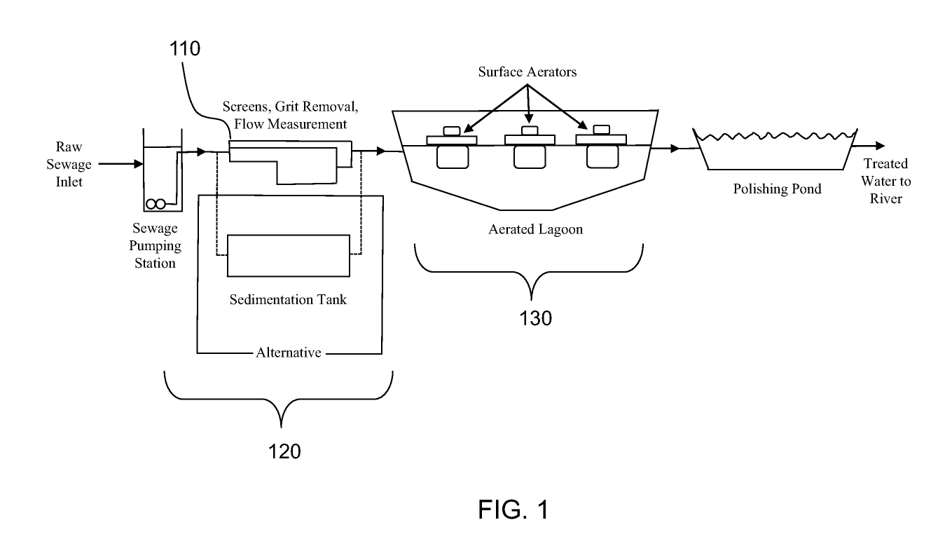

FIG. 1 is a diagrammatic representation of a wastewater treatment plant having a pretreatment process 110, a primary treatment process 120 and a secondary treatment process 130. The pretreatment 110 removes heavy materials such as trash, leaves, branches, etc., that can easily be collected from raw wastewater before damage is caused by clogging pumps are skimmers in the primary and secondary treatment processes. Pre-treatment may include screening the wastewater for such heavy materials by use of a screen or a rake passed through the wastewater to accumulate the heavier material on the screen which can then be removed manually or mechanically. Also, the flow of the wastewater may be adjusted to allow settlement of sand gravel, stones and broken glass for example. Particles of this type or kind can also damage pumps and other equipment in the treatment facility.

In primary treatment 120 the wastewater generally flows into large tanks called clarifiers, or sedimentation tanks, and these are used to initially settle sludge and to allow grease and oil accumulating on the surface where it can be skimmed off. The primary treatment 120 can include settling tanks equipped with the mechanically driven scrapers to drive the sludge towards a hopper in the base of the tank and skimmers at the surface for collecting the grease and oil, often times referred to as sapofication.

The wastewater is then transferred generally via a pump to a secondary treatment process 130 which often entails a lagoon or pool where most conventional water treatment facilities use aerobic biological processes to break down the biological materials in the wastewater. These aerobic processes require sufficient oxygen and food so that this aeration can take place for example in the lagoon. The aerators are often motor driven aerators floating on the surface of the wastewater in the lagoon. This aeration often causes a significant turbulence on the surface of the water which then of course propagates outwards to the edges of the lagoon. Over time this turbulence if significant can wear away the banking and berm potentially compromising the lagoon. The liner and fasteners described in further detail below ensures that such turbulence does not erode the banking of the lagoon and that installation of this device does not impact the operation or efficiency of the lagoon.

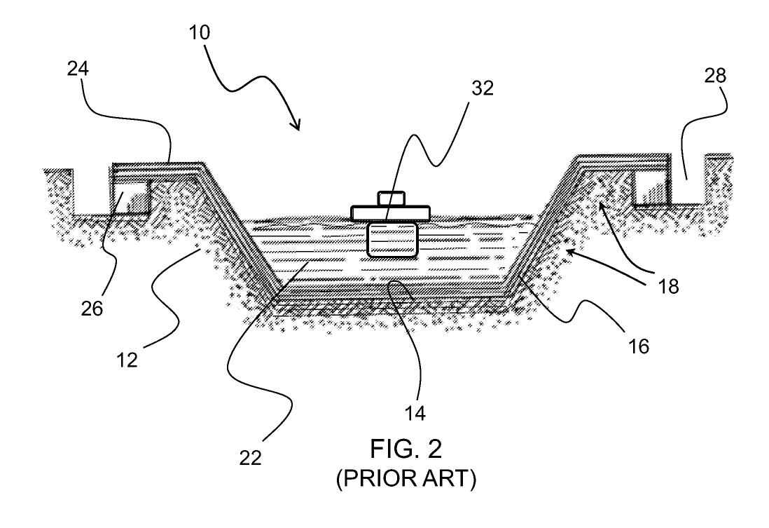

FIG. 2 is a cross-section of a lagoon 10 with the cross-hatching indicating a soil layer 12 which can be a clay layer or other type of porous, semi-porous or non-porous soil defining the lagoon itself. The lagoon 10 has a bottom 14, a banking 16 and a berm 18 is built up to form a rim around the lagoon 10 which helps contain the wastewater 22 and a lagoon liner 24 is set in place covering the entire interior surface area of the lagoon 10 and the berm 18. As shown in FIG. 2 the liner 24 stretches across the entire bottom 14, banking 16 and berm 18 of the lagoon 10 and is fastened to a retaining wall 26 which encircles the lagoon 10 and supports the berm 18. The banking 16 and berm 18 maybe at any slope and commonly a trench 28 is built within which the retaining wall 26 is positioned.

An aerator 32 may be positioned in the lagoon 10 to supply oxygen to the wastewater 22. An ample oxygen supply in a wastewater lagoon is the key to rapid and effective wastewater treatment. Oxygen is needed by the bacteria to allow their respiration reactions to proceed rapidly. The oxygen is combined by the bacteria with carbon to form carbon dioxide. Without sufficient oxygen being present, bacteria are not able to quickly biodegrade the incoming organic matter. In the absence of dissolved oxygen, degradation must occur under septic conditions which are slow, odorous and yield incomplete conversions of pollutants. Under septic conditions without aeration, some of the carbon will react with hydrogen and sulfur to form sulfuric acid and methane. Other carbon will be converted to organic acids that create low pH conditions in the ponds and make the water more difficult to treat. For example, treated ponds designed to biodegrade wastewater pollutants without oxygen often must hold the incoming sewage for six months or longer to achieve acceptable levels of pollution removal. This is because the biodegradation of organic matter in the absence of oxygen is a very slow kinetic process.

Motor driven, mechanical aerators provide a combination of liquid aeration and mixing. Some mechanical aerators produce the gas-liquid interface by entraining air from the atmosphere and dispersing it into bubbles. Other types disperse liquid in the form of droplets or they produce jets or thin films as a spray that contact the ambient air. Some other types even generate both liquid droplets and air bubbles. Mechanical aerators create turbulence on the surface of the pond, this turbulence is beneficial in that turbulence facilities gas-liquid interface however, the turbulence has consequential side effects where the turbulence reaches to the banking and berms of the lagoon and creates erosion where no liner is utilized. Until now, the only solution to such erosion has been to ameliorate the effects by using a full lagoon liner as shown and described in FIG. 2.

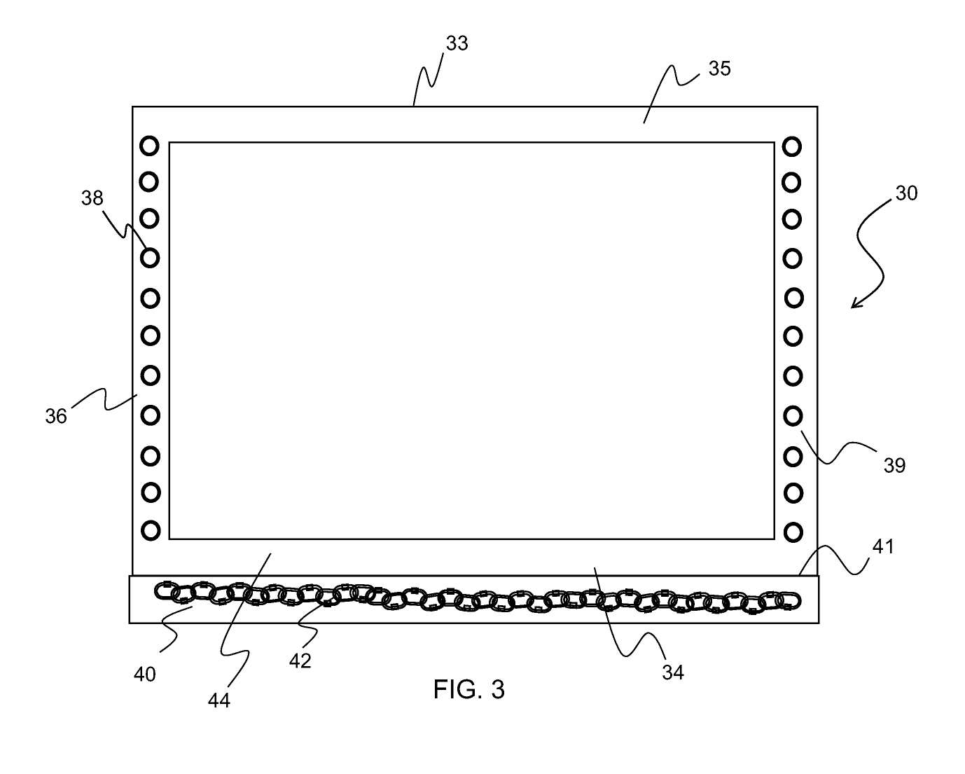

Turning to FIG. 3, a single panel 30 of the present invention is shown having a substantially rectangular shape defined by a top edge 33, a bottom edge 34 and opposing side edges 36. The top and bottom edges 33, 34 are reinforced with 2 inch nylon webbing 35 sewn along the entire length of the panel 30 and the side edges 36 are similarly reinforced with 3 inch nylon webbing 39 sewn along each the length of the sides 36. Other sizes and material reinforcements may be used as well. The side edges 36 are further provided with a plurality of grommets 38, for example stainless steel grommets, defining holes in and through the nylon webbing 39 and panel material. These holes align with the holes on adjacent panels and provide fastening points through which fasteners, such as stainless steel nuts and bolts for example, can secure adjacent panels 30 together.

Along the entire bottom edge 34 of the panel 30 is a pocket 40 sewn into the panel by overlapping the lowermost edge of the panel on itself and sewing the lowermost edge along a stitch line 41 to define the pocket 40. The overlap of the lowermost edge 34 can be in the range of about 1-3 inches so that the pocket 40 can accommodate a ½ to 1 inch chain or other ballast 42 inserted into the pocket 40 along the entire bottom edge 34 of the panel. The chain or ballast 42 is stretched through the pocket 40 so that the weight of the chain 42 is essentially uniform along the length of the panel 30 and so that the panel lies evenly and uniformly along the berm 18 and banking 16 of the lagoon 10 as described in further detail below. The reinforcing nylon webbing 44 at the bottom edge of the panel 30 is, in one embodiment, sewn in conjunction with the stitch line 41 which defines the overlap and joining of the lowermost edge of the panel 34 to the panel to define the pocket 40. Thus the pocket 40 actually hangs below the nylon webbing 44 at the bottom edge 34 of the panel 30. This arrangement of the lower reinforcing nylon webbing 44 is important because the panel 30 is most susceptible to failure along the stitch line 41 which defines the pocket 40. While there is some potential wear of the panel 30 material along the pocket portion of the panel 30, a hole or abrasion here which exposes the chain or ballast 42 will not cause failure of the panel 30. On the other hand failure of the stitching along the pocket 40 can compromise the entire pocket 40 and permit the chain or ballast 42 to fall entirely out of the pocket.

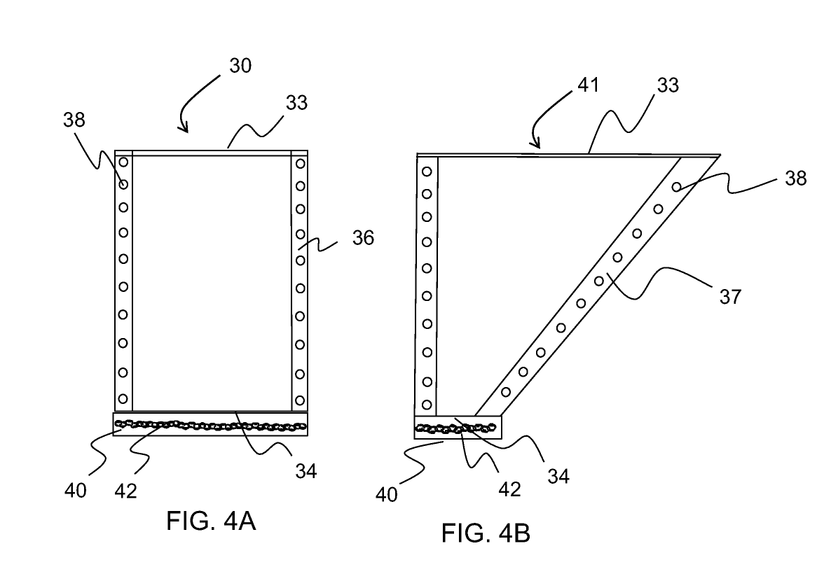

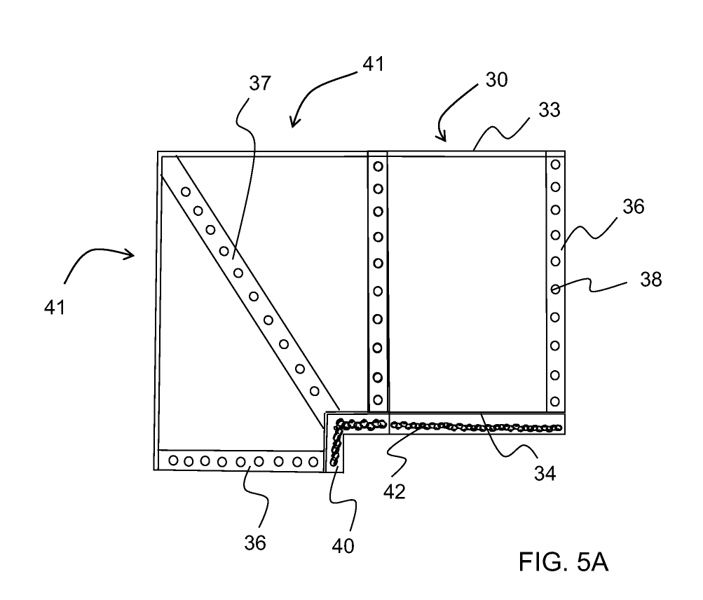

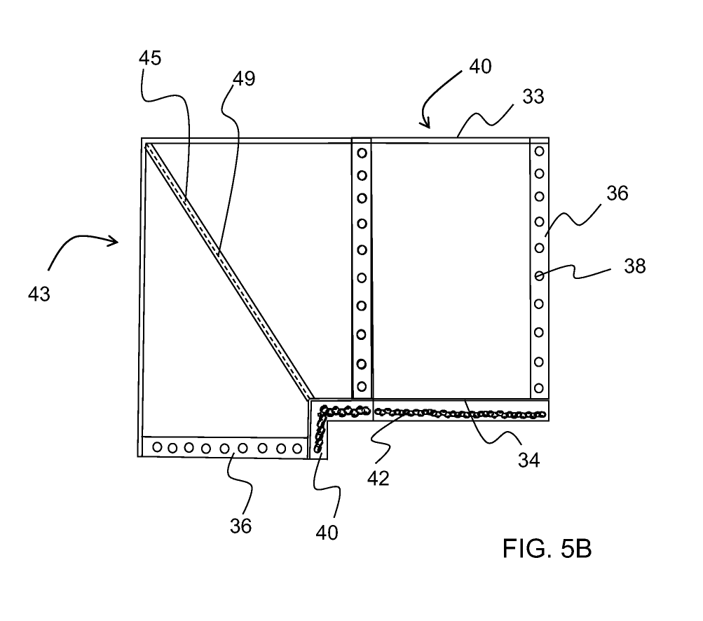

It is to be appreciated that lagoons may be of any size and shape, but are generally circular, square or rectangular. The size and shape of different lagoons may determine the specific size and shape of the panels used in a certain lagoon. For example as seen in FIGS. 4A and 4B a variety of shapes may be formed to accommodate corners, lengths and angles of various shaped lagoons. In FIG. 4B a side edge 37 of a corner panel 41 may be cut at an angle, here a 45 degree angle, to mate with a similar angled side edge 37 of an adjacent corner panel 41 to complete the right angle corner as shown in FIG. 5A. Alternatively a complete corner panel 43 may be sewn and reinforced with webbing 45 along an angled intermediate stitch line 49 as seen in FIG. 5B so that the side edges of the corner panel are at 90 degrees relative to one another.

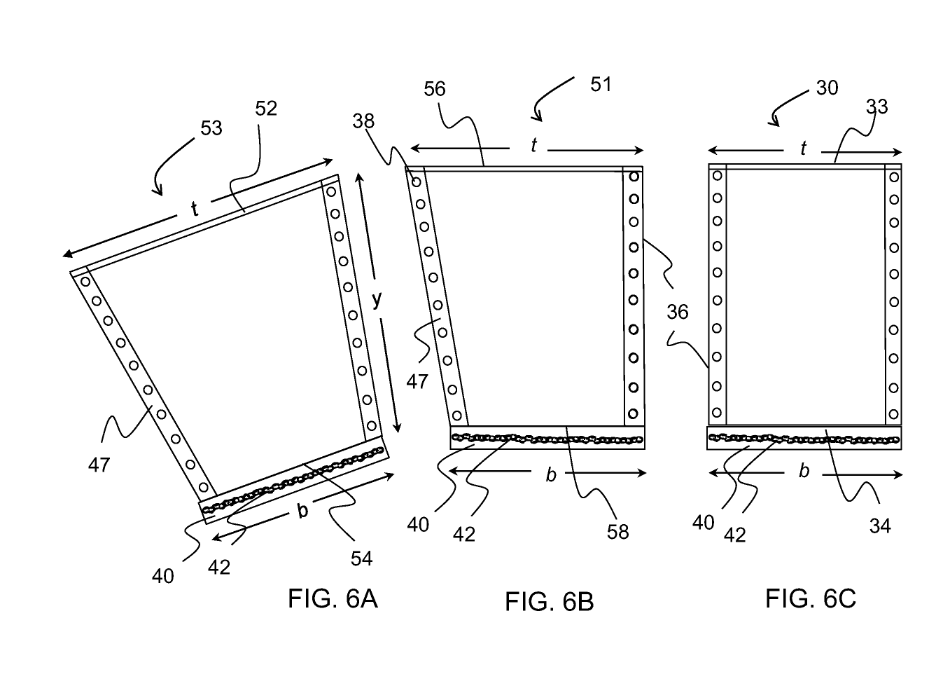

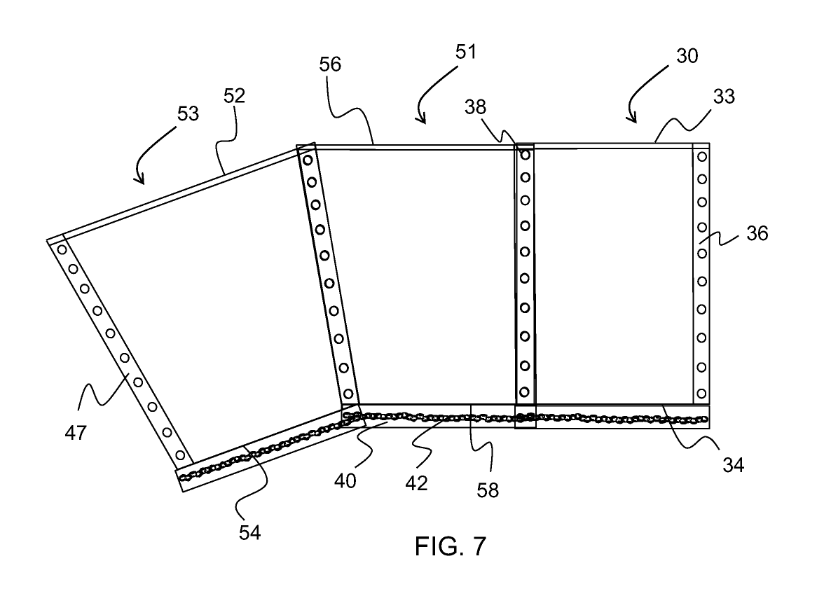

An alternative panel shape shown in FIG. 6A shows the panel 53 in another embodiment being trapezoidal in nature to account for the slope and change in diameter between the upper most lip of a lagoon and a point lower down on the banking 16 where the bottom edge 54 of the panel rests. The diameter of the lagoon changes as the banking 16 slopes down into the lagoon and has a smaller diameter than that of the upper lip of the bank or berm 18. To determine the appropriate trapezoidal shape for such a panel, the difference between the length of the circumferential top lip 52 and the circumferential length y of the desired banking point where the bottom edge 54 of the panel will lie, is determined by any conventional measurement process. This difference, divided by the number of panels required to encircle the lagoon, gives the approximate unit of measurement difference between the top edge length t and the bottom edge length b for each panel required to circumscribe the lagoon or pond and account for the slope of the banking 16 and berm 18. An intermediate panel 51 shown in 6B may be formed with a first side edge 47 that matches the side edge 47 of the trapezoidal panel 53 and a second straight edge 36 that matches the side edge of a panel 30. The side edge 47 of the trapezoidal shape of panel 53 and the intermediate panel 51 may be at an angle of 0 to 45 degrees to match the measurement difference of the top edge t to the bottom edge b of a required corner or rounded banking of the lagoon. The top edge 56 and bottom edge 58 of the intermediate panel may be of any length that maintains a flat seam along the side edge 36 and side edge 47. The intermediate panel 51 may mate with the trapezoidal panel 53 and the rectangular panel 30 as shown in FIG. 7. Flexibility in panel shape is an important aspect of the present invention thus allowing the panels to be closely aligned without creating rolls or ridges within the panel that could form gaps and cause water seepage and erosion below a panel.

Separate panels are secured together along adjacent side edges by overlapping the side edges and aligning the respective grommets and holes in the adjacent panels. One manner of securing the side edges is the insertion of a bolt through each aligned hole and securing of the bolt in the hole by a nut. The bolt head and nut of course being larger than the hole in the side edge of the panel. Other methods of fastening the aligned side edges of the panels such as with clips or other fasteners are also contemplated.

It is an important aspect of the present invention that the liner system and panels can be placed in position and into operation without having to interrupt operation of the wastewater treatment system and lagoon. Because, while it is to be appreciated that the panels may extend to any length within the lagoon, the panels do not need extend entirely across and along the bottom of the lagoon, the entire circumferential ring of panels can be assembled around the edge of the lagoon and placed into position in the lagoon while the treatment plant or system continues to operate.

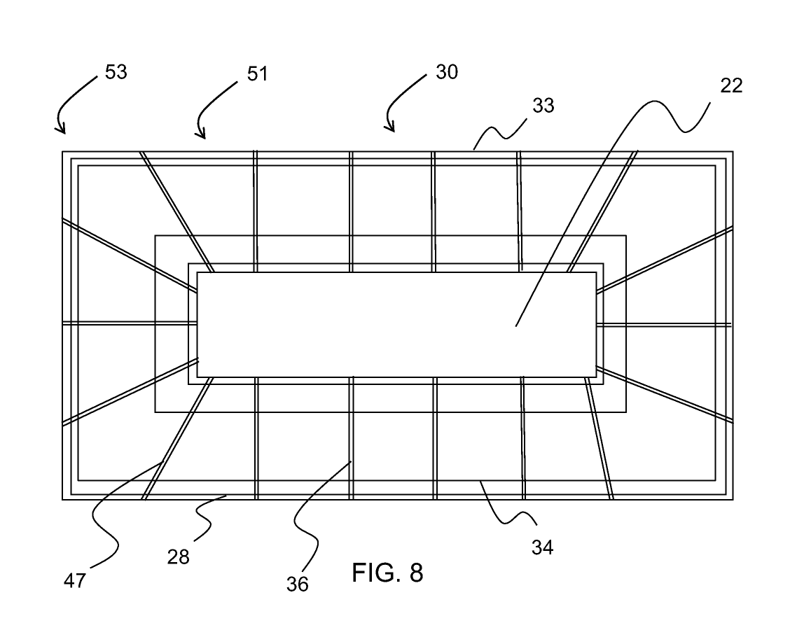

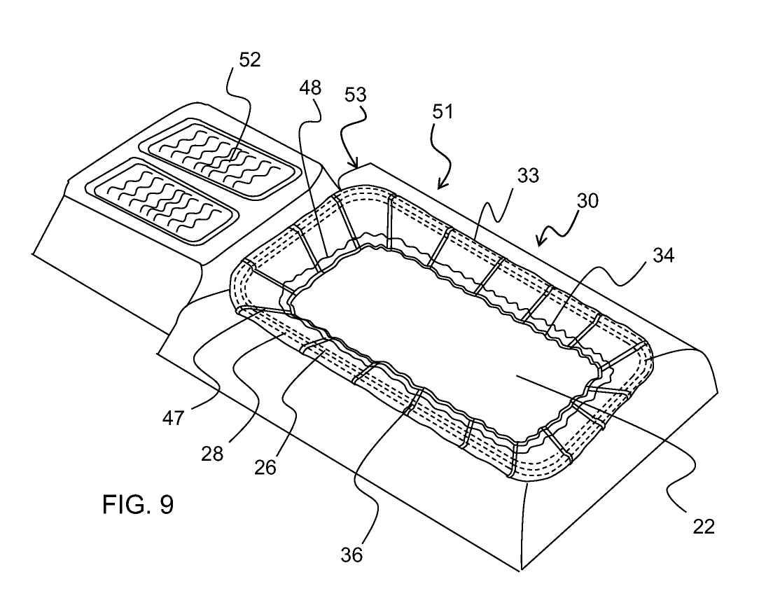

In FIG. 8 a diagrammatic plan view of a plurality of panels attached together and forming a complete ring for encircling a substantially rectangular lagoon is shown. A perspective view of a lagoon with an embodiment of the present invention is shown in FIG. 9. In these examples, trapezoidal panels 53 and intermediate panels 51 are used to enclose the corners of the rectangular lagoon and rectangular panels 30 cover the other portions of the lagoon berm 18 and banking 16. Each panel may be at only a short distance below the water's surface 48 or may extend further into the lagoon to any distance depending on the solubility of the banking 16 and the turbulence of water within the lagoon. The tops of the panels may extend over the retaining wall 26 and be secured within a trench 28 encircling the lagoon. Pretreatment sedimentation tanks 52 are also shown.

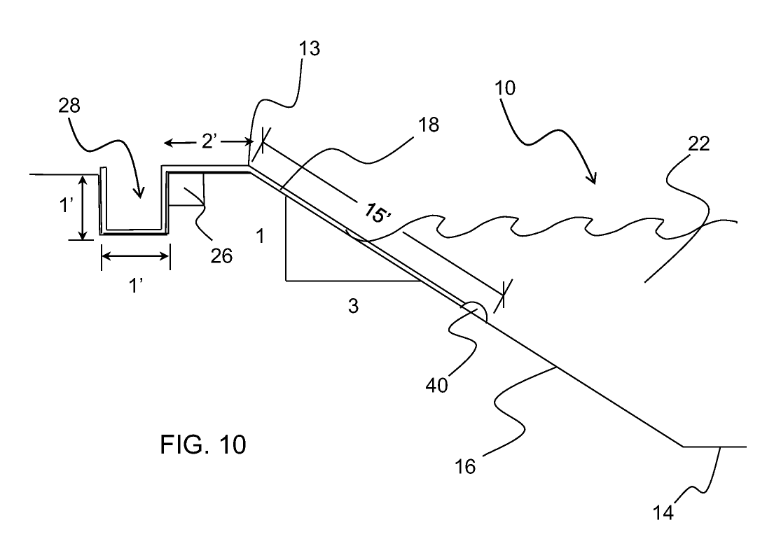

An embodiment of panel dimensions is shown in FIG. 10. As seen in this embodiment, a cross-section of the panel has a first portion of the panel which is secured within the trench 28 and extending up and around the retaining wall 26 along the circumference of the lagoon. Where a panel is provided for example with a width of 20 feet, 3 feet of the width generally defines this first portion which is secured by entraining this first portion of the panel within a trench 28 under, and partially around the retaining wall. An intermediate section of approximately 2 feet extends across the top of the berm 18, and a majority of the panel of approximately 15′ then depends down the slope of the banking into the lagoon where the bottom edge of the panel including the pocket 40 having the chain or ballast 42 therein. Again, because each panel comprising the liner can be attached to the adjacent panel and then positioned down into the lagoon even below the water level, the treatment and operation of the wastewater lagoon and facility is not interrupted.

In this way an erosion control lagoon liner can be constructed and implemented inexpensively and without interruption of facility operation for installation of the device. Additionally, a single panel can be easily replaced by disengaging the side edges removing the panel and replacing with a similar replacement panel, all without interruption of facility operation. One embodiment of the liner and panels involves the use of 3028 XR5® material a highly resistant, non-degradable membrane surface with extreme puncture and tear resistance as well as dimensional stability under high loads and extreme temperature fluctuations. Other containment and liner materials can be used as well.

The invention has been described in detail with particular reference to certain preferred embodiments thereof, but it will be understood that variations and modifications can be effected within the spirit and scope of the invention.

I/We claim:

1. A pond or lagoon liner comprising:
a plurality of panels fastened together to define a ring which circumscribes the pond or lagoon;
each panel comprising:
a top edge, a bottom edge and opposing side edges;
a pocket formed at the bottom edge of each panel;
a ballast supported in the pocket of each panel; and
wherein the side edges of adjacent panels are fastened together to align the respective top and bottom edges of adjacent panels defining a circumferential upper edge of the liner and a substantially parallel circumferential lower edge of the liner.

2. The pond or lagoon liner as set forth in claim 1 further comprising a plurality of fastening points spaced along the opposing side edges of each of the plurality of panels.

3. The pond or lagoon liner as set forth in claim 1 further comprising a reinforcing webbing applied along the top edge, bottom edge and opposing side edges of each panel to further reinforce the liner encompassing the pond or lagoon.

4. The pond or lagoon liner as set forth in claim 3 wherein the pocket is formed on the bottom edge of each panel by overlapping a lowermost edge of each panel and affixing the lowermost edge along a length of the panel.

5. The pond or lagoon liner as set forth in claim 4 wherein the reinforcing webbing applied along the bottom edge facilitates the support and the affixing of the lowermost edge to the panel in defining the pocket for the ballast.

6. The pond or lagoon liner as set forth in claim 1 wherein the plurality of panels are fastened together and the liner is positioned in the pond or lagoon and extending partially down a banking into the pond or lagoon.

7. The pond or lagoon liner as set forth in claim 6 wherein the plurality of panels are fastened together and the liner is positioned in the pond or lagoon without emptying the pond or lagoon of fluid.

8. The pond or lagoon liner as set forth in claim 6 wherein the plurality of panels are fastened together and the liner is positioned in the pond or lagoon without interruption of facility operation.

9. The pond or lagoon liner as set forth in claim 1 wherein the top edge of each panel is secured above a fluid surface level in the pond or lagoon and the bottom edge of each panel is a free end supported on a banking below the fluid surface level in the pond or lagoon and maintained in place by the ballast in the pocket.

10. A method of preventing erosion in a fluid treatment pond or lagoon comprising the steps of:
fastening together a plurality of panels to define a ring which circumscribes the pond or lagoon;
fabricating each panel having a top edge, a bottom edge and opposing side edges;
forming a pocket at the bottom edge of each panel;
supporting a ballast in the pocket of each panel; and
fastening the side edges of adjacent panels together and aligning the respective top and bottom edges of adjacent panels to define a circumferential upper edge of the liner and a substantially parallel circumferential lower edge of the liner.

11. The method of preventing erosion in a fluid treatment pond or lagoon as set forth in claim 9 further comprising the step of applying a reinforcing webbing along the bottom edge to facilitate support and affixing of a lowermost edge to the panel in defining the pocket to support the ballast.

12. The method of preventing erosion in a fluid treatment pond or lagoon as set forth in claim 9 further comprising the step of fastening the plurality of panels together and positioning the liner in the pond or lagoon extending partially down a banking into the pond or lagoon.

13. The method of preventing erosion in a fluid treatment pond or lagoon as set forth in claim 11 further comprising the step of positioning the liner in the pond or lagoon without emptying the pond or lagoon of fluid.

14. The method of preventing erosion in a fluid treatment pond or lagoon as set forth in claim 12 further comprising the step of securing the top edge of each panel above a fluid surface level in the pond or lagoon and freely supporting the bottom edge of each panel on the banking below the fluid surface level in the pond or lagoon and maintaining the bottom edge in place against the banking by the ballast in the pocket.

15. The method of preventing erosion in a fluid treatment pond or lagoon as set forth in claim 12 further comprising the step of installing the liner in the pond or lagoon without interruption of facility operation.
